(19) United States
(12) Patent Application Publication
(10) Pub. No.: US 2025/0378060 A1
(43) Pub. Date: Dec. 11, 2025

(54) GENERATING KEYS FOR SEMI-STRUCTURED DATA STORAGE IN RELATIONAL DATABASES

(71) Applicant: Oracle International Corporation, Redwood Shores, CA (US)

(72) Inventors: Zhen Hua Liu, San Mateo, CA (US); Sundeep Abraham, Redwood City, CA (US); Ramesh Kumar, Foster City, CA (US); Douglas James McMahon, Redwood City, CA (US); Beda Christoph Hammerschmidt, Palo Alto, CA (US); Joshua Spiegel, St. Louis, MO (US)

(21) Appl. No.: 19/301,062

(22) Filed: Aug. 15, 2025

Related U.S. Application Data
(63) Continuation-in-part of application No. 18/987,968, filed on Dec. 19, 2024.
(60) Provisional application No. 63/573,378, filed on Apr. 2, 2024.
(60) Provisional application No. 63/836,057, filed on Jun. 30, 2025.

(51) Int. Cl. G06F 16/22; G06F 16/25; G06F 16/93

(52) U.S. Cl. CPC G06F 16/2282; G06F 16/258; G06F 16/93

(57) ABSTRACT

Techniques are described for generating index-friendly homomorphic key values for indexing semi-structured data documents in a collection when storing the collection in a relational database management system (DBMS). In an implementation, a request is received from a client application to store a semi-structured data document collection into a target table of the relational DBMS. Without ascertaining any schema information for a document in the collection, the techniques determine whether the document fails to include an identifier that uniquely identifies the document in the collection. Techniques further include generating a unique identifier that identifies the document in the collection, if no identifier exists, and materializing the identifiers of the collection into indexable primary key values for the target relational table.

### BENEFIT CLAIM

This application claims the benefit under 35 U.S.C. § 119 (c) of provisional application 63/836,057, filed Jun. 30, 2025, by Liu et al., and under 35 U.S.C. § 120 as a continuation-in-part of U.S. patent application Ser. No. 18/987,968, titled “EFFECTIVE AND EFFICIENT SUPPORT OF JSON DATATYPE COMPARISON”, filed on Dec. 19, 2024, which claims benefit under 35 U.S.C. § 119 (c) of provisional application 63/573,378, filed Apr. 2, 2024 by Liu et al, the entire content of each of which is hereby incorporated by reference. The applicant hereby rescinds any disclaimer of claim scope in the parent applications or the prosecution history thereof and advise the USPTO that the claims in this application may be broader than any claim in the parent application.

### FIELD OF TECHNOLOGY

The present invention relates to the field of electronic database management, in particular to generating keys for semi-structured data storage in relational databases.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Collections of semi-structured objects may be stored in non-relational (“NoSQL”) databases. Such collections support a schema-less or schema-later development style, as opposed to relational databases that have schema-based restrictions on the storage of objects. In a NoSQL database, there is no need to restrict data to specifically named and strongly typed columns, nor to require flat or decomposed models for storage. Accordingly, the objects stored in a NoSQL database are equivalent to having a table with only one, e.g., form-permissive datatype column (e.g., JSON) storing an object per row in a relational database. Such objects are often referred to as “documents” in NoSQL databases

Document-based NoSQL databases may still identify each specific document of semi-structured data via an object identifier. Such an identifier is stored intrinsically as a required field found within each document. For example, in the JSON format, the field named “_id” is commonly used for uniquely identifying each document in a collection. Thus, conceptually, the “_id” field acts as the primary key column for a relational table if stored in a relational database.

However, even when the document-identifying field is standardized (e.g., _id), the inherent flexibility of JSON and other semi-structured data formats creates significant technical challenges for storing documents in a relational database. For example, there is no fixed schema to describe the format of the identifier field for the document, such as the data type (e.g., integer, string, character), data structure (e.g., primitive, scalar, collection, composite) and other format properties. The identifier of documents may be heterogeneous data with heterogeneous value(s).

The issue is further exacerbated when the document is missing the identifier field. Because NoSQL databases do not require any unique identifier like relational DBMSs may, the document may be missing the identifier field altogether or have a blank value for it. Accordingly, not only may the shape of the identifier be inconsistent, but the identifier field may not exist or have an empty value.

Therefore, a relational DBMS, requiring a fixed number of strongly typed key columns, cannot extract and store the known identifier field to manage the documents for indexing and search purposes. Accordingly, even when the identifier field name is known for the collection, the field cannot be readily used as a primary key column for storing semi-structured documents.

One approach to store semi-structured data in a relation DBMS is to ascertain the existence and format of the identifier for the data beforehand. After doing so, the approach may additionally require a particular DDL (Data Definition Language) statement designed for the source semi-structured data-formatted documents to verify the target table compatibility in the relational DBMS. Therefore, this “schema-first” approach may have to examine both the schema of the source documents as well as the schema of the target table on the DBMS for the documents to be stored in. By acquiring the format of the source documents and examining the schema of the target table, the program logic may store the source documents by converting the necessary document data into target-table conformant data and storing the converted data into the target table. However, since many semi-structured data applications employ “data first, schema later”, requiring such logic in the application is not a practical application development practice.

Additionally, these processing steps not only require complex program logic but also an additional round-trip to the relational DBMS to examine the schema of the target table. When storing a collection of semi-structured data format documents, such roundtrips to the DBMS may be performed multiple times to verify that the target table schema continues to match the cached objects on the client side of the DBMS. Therefore, the approach is not only complex but also adds additional lag and compute resource consumption.

### BRIEF DESCRIPTION OF THE DRAWINGS

In the drawings of certain embodiments in which like reference numerals refer to corresponding parts throughout the figures:

FIG. 1 is a block diagram that depicts a process for converting a semi-structured data document collection into a suitable format for storing in a relational DBMS, in an implementation;

FIG. 2 is a sequence diagram that depicts the process for storing a JSON document collection into a relational DBMS, in an implementation;

FIG. 3 is a block diagram that depicts a process of storing semi-structured document(s) in a relational DBMS, in an implementation;

FIG. 4 is a block diagram of a basic software system, in one or more embodiments;

FIG. 5 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, structures and devices are shown in block diagram form in order to avoid unnecessarily obscuring the present invention.

### GENERAL OVERVIEW

The approaches herein describe generating index-friendly homomorphic key values for indexing semi-structured data documents in a collection when storing the collection into a relational database management system (DBMS). A client-side application, rather than having program logic to perform “schema first” computations, may directly request a collection of semi-structured documents to be stored in a relational DBMS. Using techniques described herein, a client-driver of a relational DBMS and/or the relational DBMS performs steps to ascertain the identifiers in the collection and, if missing, generate identifier(s) therefor, without using additional computational and network resources, improving the query performance, especially for the client-side.

The techniques further improve the queryability of semi-structured data collections by taking advantage of relational database indexing. In an implementation, an identifier field in a semi-structured data document is determined and extracted as a primary key for a primary key column of the table storing the semi-structured data document. The identifier field uniquely identifies the semi-structured document in the collection and may be known based on industry standards or general practice. Accordingly, such an identifier field may be pre-configured to be selected as a primary key.

In an implementation, to accommodate the flexibility in formatting of the selected identifier field, the field value is extracted from the document and converted to a raw (binary-encoded) format when storing as a primary key. Such a raw format may be a memcomp-compatible format as described in the U.S. patent application Ser. No. 18/987,968, titled “EFFECTIVE AND EFFICIENT SUPPORT OF JSON DATATYPE COMPARISON”, filed on Dec. 19, 2024, (referred to herein as “Memcomp-compatible Format Patent Application”) the entire contents of which are hereby incorporated by reference as if fully set forth herein, Additionally, the DBMS may store the generated raw key value in the semi-structured data document when the document is stored in association with the raw primary key value in the table.

In an implementation, to further improve the performance of storing semi-structured data collection, the generating of the missing identifier(s) of document(s) is delegated to the relational DBMS without the extra cost of re-parsing/encoding semi-structured data document(s) by the DBMS. In such an implementation, the client-side driver of the DBMS determines that the identifier field is not present in a semi-structured data document and allocates a memory space for the to-be-generated raw key value in the document. The determination and allocation may be performed during the conversion of the semi-structured document into a storage format suitable for the relation DBMS, further saving client-side computational resources.

In an implementation, the collection of semistructured documents to be stored by the relational DBMS may be in JSON format. JSON is an open standard file format and data interchange format that uses human-readable text to store and transmit data objects consisting of attribute-value pairs and arrays. JSON is a language-independent data format developed in the early 2000s. Internet Engineering Task Force (IETF) Request for Comments (RFC) 4627 provides further detail and specifies that JSON can represent four primitive types (strings, numbers, Booleans and null) and two structured types (objects and arrays). JSON is described in further detail in U.S. patent application Ser. No. 17/966,724, NATIVELY SUPPORTING JSON DUALITY VIEW IN A DATABASE MANAGEMENT SYSTEM, filed on Oct. 14, 2022 by Zhen Hua Liu, et al., the entire contents of which are hereby incorporated herein by reference, and in U.S. patent application Ser. No. 17/966,716, TECHNIQUES FOR COMPREHENSIVELY SUPPORTING JSON SCHEMA IN RDBMS, filed on Oct. 14, 2022 by Zhen Hua Liu, et al., the entire contents of each of which are hereby incorporated herein by reference. CONVERTING DOCUMENTS FOR RELATIONAL DBMS

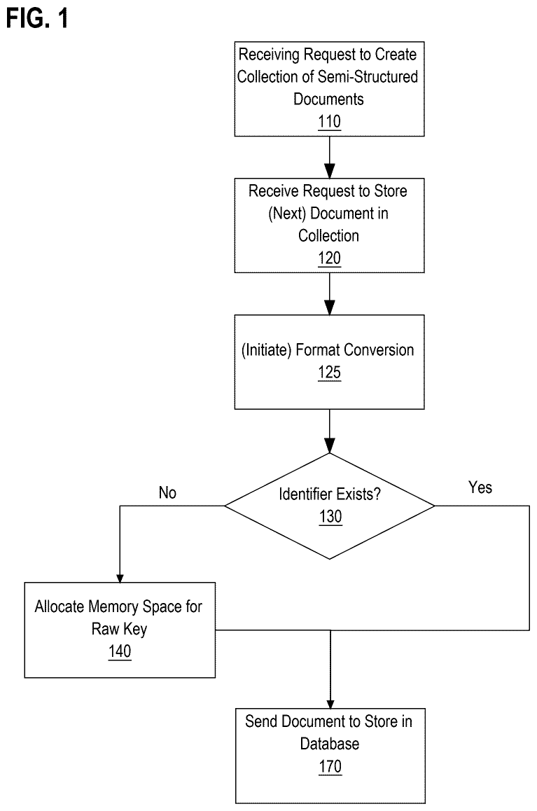

FIG. 1 is a block diagram that depicts a process for converting a semi-structured data document collection into a suitable format for storing in a relational DBMS, in an implementation. Although a client driver is described as being separate from a DBMS, the techniques described herein may be performed with the client driver integrated into the relational DBMS. Stated differently, in another implementation, the client driver is part of the DBMS, and the relational DBMS may perform the steps described herein for the client driver. Additionally, one or more of the steps described below may be omitted, repeated, and/or performed in a different order. Accordingly, the specific arrangement of steps shown in FIG. 1 should not be construed as limiting the scope of the invention. Further, the steps shown below may be modified based on the semi-structured data type of documents.

At step 110, the client driver receives from a client application a request to store a collection of semi-structured documents into the relational DBMS. The semi-structured document collection may contain one or more documents, and the request may contain the target table of the relational DBMS into which to store the collection. For example, the DDL for creating a target table for storing JSON data document collection may be in the form of: CREATE JSON COLLECTION TABLE <collection_name>

In response to the request, the relational DBMS creates a relational table that includes at least two columns, a primary key column and a data storage column, in such an example. The data storage column may store each semi-structured document in a row associated with the corresponding primary key, storing the unique identifier of the document in the collection. Additionally, the table may contain other columns. For example, another column of the table may contain a unique value representing that a value has been added (e.g., using an INSERT statement) or updated (e.g., using an UPDATE statement).

Primary Key Materialized from Document Identifier

In an implementation, the primary key of the semi-structured data table is a materialized column. The value for the primary key is generated based on an identifier field in each semi-structured document to be stored in the corresponding row of the relational table.

For example, in a JSON document collection, each document may contain a field “_id” which is unique for each document in the collection. Other semi-structured data may have a different identifier field for a document in the collection. For example, for an extensible Markup Language (XML) document collection, the identifier field may be the “xml: id” attribute at the root node of the document.

In an implementation, the client application may specify, or the client driver/DBMS may be pre-configured, to which field in semi-structured data contains the identifier field. This field is to be treated as the source data for the primary key column of the semi-structured document storage in the relational DBMS.

Accordingly, the target table of the DBMS may be configured to use the identifier field in the semi-structured document collection as the “materialized” primary key for the target table. Such a materialized primary key is therefore an extracted identifier that is physically stored and maintained independently of the source semi-structured data document. Unlike virtual or computed keys that are generated dynamically during query execution, materialized keys exist as persistent database objects and thus may be indexed, referenced, and optimized for performance.

In an implementation, the DBMS defines the primary key column for the semi-structured data table to have additional limitation(s). For example, the primary key column may be defined in a raw format, allowing its values to be compared to one another (e.g., for indexing and sorting purposes). Accordingly, when the identifier field value is materialized by the DBMS, the pre-defined field value in the document is converted to the corresponding raw format value. An example of a raw format value is a memcomp-compatible format of the Memcomp-compatible Format Patent Application. With the memcomp-compatible format, the materialized primary key column values of the target table have values that may be compared to each other and thus may be sorted and/or indexed.

Another limitation may be that the primary key value is a scalar. Stated differently, when materializing, the DBMS performs verification that the identifier field value in the semi-structured document is of non-array type. If the pre-defined field value in the semi-structured document is an array, the insertion of the corresponding semi-structured document may fail.

Additionally, the primary key may be defined as invisible and/or immutable after its generation and storage. Accordingly, once the semi-structured data document is stored in such a table, the primary key may not be visible to user queries and/or may not change based on such user queries.

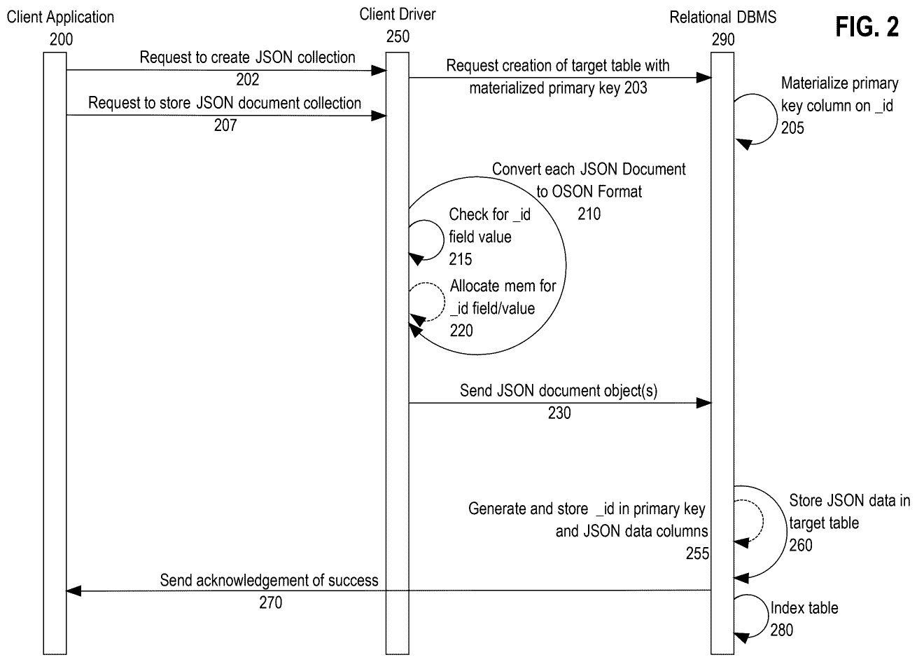

Continuing with the example of JSON document collection, FIG. 2 is a sequence diagram that depicts the process for storing JSON document collection into a relational DBMS, in an implementation. Client Application 200 may initially request Client Driver 250 to create a JSON collection target table on relational DBMS 290 at step 202 to store the JSON collection. The creation may be requested by Client Application 200 by issuing an SQL command containing the DDL statement “CREATE JSON COLLECTION TABLE <collection_name>”, as described above. Client Driver 250 may request the DDL statement to be executed on DBMS 290 at step 203.

Relational DBMS 290 may be configured to create the target table having the primary key of the target table materialized from the “_id” field of the corresponding JSON document, at step 205. Alternatively, DBMS 290 may be configured to materialize the primary key column upon request for the creation of a JSON document collection table at step 205.

An example of the statement for DBMS 290 to be configured to create a materialized primary key column on the basis of the “_id” field is:
RESID INVISIBLE AS (JSON_VALUE(DATA, ‘$.id’ RETURNING ANY ORA_RAWCOMPARE NO ARRAY ERROR ON ERROR)) MATERIALIZED IMMUTABLE

where the primary key column is invisible to the user and is immutable once materialized.

Continuing with FIG. 1, the client application may request the client driver to insert one or more of semi-structured documents into the target relation table (created at step 110). Accordingly, at step 120, the client driver may receive from the client application a request to store document(s) of the collection in the target table of the relational DBMS. For example, the client driver may receive a DML statement to insert one or more documents into the target table.

### Rectifying Missing Identifier Value

Continuing with FIG. 1, at step 125, the client driver may convert the received semi-structured data document(s) into a format suitable for storage of semi-structured documents in the target relational table. At step 130, the client driver determines whether an identifier field value exists in the received semi-structured document(s). In an implementation, to save resources from separately traversing the semi-structured document(s) for field values, the client driver determines whether the identifier field value exists during the conversion into the raw format at step 125. In such an implementation, the client driver initiates the encoding of the received semi-structured data document into a format suitable for storage of semi-structured documents in a relational table at step 125 and determines the existence of the identifier field value at step 130.

If an identifier field value exists at step 130, then the client driver proceeds to complete the encoding into the raw format of the received document and proceeds to step 170. However, if no identifier field value is determined to exist at step 130, the client driver first allocates memory space for the identifier field and its value in the document at step 140 before completing encoding and proceeding to step 170.

When the memory for a missing identifier value is allocated in the document, the client driver improves the performance of both the client driver and the relational DBMS. With allocated space, the client driver delegates the computationally intensive task of generating an identifier to the resource-rich DBMS. Also, the DBMS no longer needs to re-encode the document to add the missing identifier and/or its value. Instead of re-encoding, the DBMS locates the allocated memory space in the document and updates the space with the field/value of the generated identifier to uniquely identify the document in the collection and thereby in the target table.

At step 170, the client driver sends the encoded document to the DBMS to store in the target table.

Continuing with the FIG. 2 JSON collection example, at step 207, Client Application 200 may issue a DML INSERT statement referencing one or more JSON documents, each to be stored in the referenced target table created at steps 203/205 to store the JSON collection.

In response, at step 210, Client Driver 250 converts each JSON document to a raw traversable format, such as OSON (described in the “OSON FORMAT OVERVIEW” section), converting the JSON document into a format suitable for storage in relational DBMS 290. During the conversion and traversal of the JSON document, at step 215, Client Driver 250 determines whether the “_id” field exists in the JSON document and if so, whether a valid value is present. If not present, Client Driver 250 pads the format with a blank field of a particular length (e.g., 16 bytes), suitable for DBMS 290 to write in a server-assigned key via a partial (in-place) update (partial OSON update). The partial update improves the functionality of JSON storage by avoiding costly re-serialization of the JSON data.

At step 230, the encoded JSON document(s) in OSON format are sent to DBMS 290 to be stored in the target JSON collection table.

### Storing Document(S) in Relational DBMS

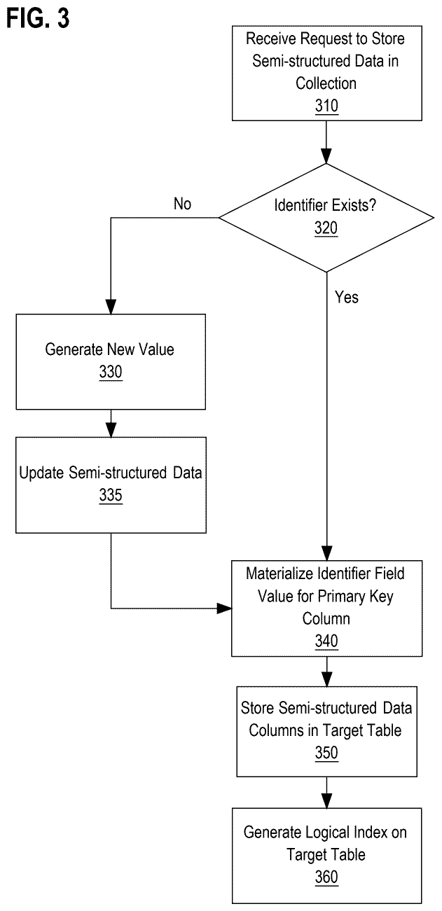

FIG. 3 is a block diagram that depicts a process of storing semi-structured document(s) in a relational DBMS, in an implementation. At step 310, the relational DBMS receives a request to store semi-structured data in a collection into a relational table for semi-structured data. The request may be in the form of a DML statement specifying the target relational table of the DBMS for semi-structured data. Such a target table may be pre-configured to materialize its primary key column based on the identifier field of the document.

At step 320, the relational DBMS determines whether an identifier field value exists in the incoming semi-structured data document. The DBMS may use traversal techniques particular to the incoming semi-structured data type to traverse to the identifier field. If the traversal fails to retrieve a non-zero/non-null value, then it is determined that no identifier field exists in the incoming data at step 320, and the process proceeds to step 330. Otherwise, the process proceeds to step 340.

At step 330, the relational DBMS generates a new value to serve as the identifier for the document in the collection. The DBMS may generate a unique hash value for the identifier field using a hash generation algorithm. Non-limiting examples of such hash generation algorithms are SHA, Blake, UUID, and MD5.

At step 335, the relational DBMS updates the incoming semi-structured data for the missing identifier field value by updating the memory allocated at step 140 for the identifier field.

At step 340, the relational DBMS materializes the identifier field value from the document into the primary key column for the incoming semi-structured data. The relational DBMS may traverse to the identifier field and retrieve the value, and store the identifier value as the primary key value in the same row as the incoming semi-structured data document.

In an implementation, the retrieved value is materialized in a raw format that may be used in comparison operations, such as a memcomp-compatible format of the Memcomp Compatible Patent Application. Accordingly, apart from being enforced to uniquely identify the incoming data, the format allows for indexing of the collection because tree-based indexing (BTree index) or other indexing methods rely on compare operations to collate values.

At step 350, the relational DBMS stores into the same row of the target table both the incoming semi-structured data and the identifier value thereof as the primary key for the row. Steps 120-170 of FIG. 1 and steps 310-350 of FIG. 3 may be performed for each semi-structured data document in the collection, thereby performing bulk storing of the collection into a relational table with index-compatible rows.

At step 360, the relational DBMS generates an index on the target table, creating indexing structures to optimize future query performance on the stored semi-structured data. One example of an indexing structure is the BTree index that uses raw comparisons of primary key values and a dictionary structure of the corresponding indexed document.

Continuing with the example in FIG. 2 of the JSON collection, Client Driver 250 sends each OSON-formatted JSON object to store in Relational DBMS 290 at step 230. When received, DBMS 290 stores OSON data into the target table by materializing the primary key to store in association with the OSON data at step 260.

At step 255, DBMS 290 determines if the “_id” field in the OSON data exists, or if so, whether the “_id” field contains any valid value (e.g., a non-blank, non-null value). If the “_id” field contains a valid value, the DBMS proceeds to materialize the “_id” field value into a memcomp-compatible format value for the primary key value of the row in which the OSON data is stored in the target table by DBMS 290.

Otherwise, at step 255, DBMS 290 generates a globally unique identifier, such as UUID, and performs an update of the allocated memory at step 220 with the generated identifier value. Such a partial (in-place) update (partial OSON update) avoids the costly re-serialization of the OSON data (which would be required in the case that no memory was allocated apriori).

Finally, the DBMS sends an acknowledgement of success at step 270 back to the Client Application 200 through Client Driver 250, confirming that the JSON document(s) have been successfully stored.

At step 280, DBMS 290 indexes the table based on the primary keys that may be compared and sorted, thereby boosting the efficiency of access to the JSON data stored in the target table.

### OSON Format Over View

OSON is a binary-encoded (raw) storage format for JSON that is optimized for relational database operations. OSON employs a hierarchical tree encoding structure where JSON documents are serialized into binary byte arrays containing embedded navigation metadata. The format utilizes jump navigation offsets that function as internal pointers, enabling direct traversal to specific document elements without sequential parsing. These offsets create a navigable tree structure where each node contains both data and positional information, allowing the database engine to locate nested elements through calculated jumps rather than iterative scanning.

The binary representation organizes data using a compressed tree structure that eliminates redundant syntax characters present in textual JSON. Field names, values, and structural indicators are encoded using variable-length encoding schemes that optimize storage density. The format maintains type information at the binary level, preserving data semantics while reducing storage overhead compared to character-based representations.

OSON extends the standard JSON type by incorporating additional scalar types that correspond to SQL data types but are not part of the JSON specification. These extensions include binary data types, precise date and timestamp representations with timezone information, year-month and day-second interval types, and enhanced numeric types including binary floating-point numbers with single and double precision. This type extension allows OSON to maintain semantic fidelity when converting between relational and document representations.

The format supports granular modification operations through its structured binary layout (piece-wise update). Rather than requiring complete document replacement for partial updates, OSON enables targeted modification of specific elements within the binary structure. This capability leverages the tree organization to identify and modify individual nodes while preserving the integrity of unchanged portions, significantly reducing computational overhead for update operations on large documents.

OSON's binary structure enables advanced query optimization techniques, including specialized indexing strategies and path expression evaluation. The format supports efficient implementation of SQL/JSON path language operations through direct navigation rather than parsing-based evaluation. The database engine can leverage the structured format to create bitmap indexes, functional indexes on JSON paths, and other optimization structures that would be computationally prohibitive with textual representations.

The format supports both client-side and server-side encoding operations, with the processing location determined by client driver capabilities and explicit configuration. Client-side encoding offloads conversion overhead from the database server and enables applications to prepare optimized binary representations before transmission. Server-side encoding provides compatibility for legacy clients while ensuring automatic conversion for standard JSON input operations.

OSON employs compression techniques that leverage the structural regularity often present in JSON documents. The binary encoding eliminates repetitive syntax elements and uses variable-length encoding for frequently occurring patterns. The serialization process creates self-contained binary objects that include both data and metadata necessary for complete document reconstruction.

The format demonstrates superior performance characteristics for both storage and retrieval operations compared to textual JSON representations. Binary encoding typically achieves better compression ratios while simultaneously enabling faster access patterns through jump navigation. Query execution benefits from reduced parsing overhead and more efficient memory utilization during processing operations.

OSON integrates natively with relational DBMS storage engine architecture, supporting transaction semantics, backup and recovery operations, and replication mechanisms without special handling. The format participates in standard database optimization processes including cost-based query planning, parallel execution, and result set caching, ensuring consistent performance characteristics across different operational scenarios.

### Database Management System Overview

A database management system (DBMS) manages a database. A DBMS may comprise one or more database servers. A database comprises database data and a database dictionary that are stored on a persistent memory mechanism, such as a set of hard disks. Database data may be organized into database objects and stored in one or more data containers. Each container contains records. The data within each record is organized into one or more fields. In relational DBMSs, the data containers are referred to as tables, the records are referred to as rows, and the fields are referred to as columns. In object-oriented databases, the data containers are referred to as object classes, the records are referred to as objects, and the fields are referred to as attributes. Other database architectures may use other terminology to refer to database objects.

In embodiments, the databases may be structured as key-value stores (e.g., NoSQL or JSON) where different database objects may represent different data structures. Key-values and associated objects can be referenced, for example, utilizing look-up tables such as hash tables.

Users interact with a database server of a DBMS by submitting to the database server commands that cause the database server to perform operations on data stored in a database. A user may be one or more applications running on a client computer that interact with a database server. Multiple users may also be referred to herein collectively as a user.

As used herein, “query” refers to a database command and may be in the form of a database statement that conforms to a database language. In one embodiment, a database language for expressing the query is the Structured Query Language (SQL). There are many different versions of SQL, some versions are standard and some proprietary, and there are a variety of extensions. Data definition language (“DDL”) commands are issued to a database server to create or configure database schema, including database containers, such as tables, views, or complex data types. SQL/XML is a common extension of SQL used when manipulating XML data in an object-relational database. Although the embodiments of the invention are described herein using the term “SQL,” the invention is not limited to just this particular database query language and may be used in conjunction with other database query languages and constructs.

A client may issue a series of requests, such as requests for execution of queries, to a database server by establishing a database session, referred to herein as “session.” A session comprises a particular connection established for a client to a database server, such as a database instance, through which the client may issue a series of requests. The database server may maintain session state data about the session. The session state data reflects the current state of the session and may contain the identity of the user for which the session is established, services used by the user, instances of object types, language and character set data, statistics about resource usage for the session, temporary variable values generated by processes executing software within the session, and storage for cursors and variables and other information. The session state data may also contain execution plan parameters configured for the session.

Database services are associated with sessions maintained by a DBMS with clients. Services can be defined in a data dictionary using data definition language (DDL) statements. A client request to establish a session may specify a service. Such a request is referred to herein as a request for the service. Services may also be assigned in other ways, for example, based on user authentication with a DBMS. The DBMS directs requests for a service to a database server that has been assigned to running that service. The one or more computing nodes hosting the database server are referred to as running or hosting the service. A service is assigned, at run-time, to a node in order to have the node host the service. A service may also be associated with service-level agreements, which are used to assign a number of nodes to services and allocate resources within nodes for those services. A DBMS may migrate or move a service from one database server to another database server that may run on a different one or more computing nodes. The DBMS may do so by assigning the service to be run on the other database server. The DBMS may also redirect requests for the service to the other database server after the assignment. In an embodiment, after successfully migrating the service to the other database server, the DBMS may halt the service running in the original database server.

A multi-node database management system is made up of interconnected nodes that share access to the same database. Typically, the nodes are interconnected via a network and share access, in varying degrees, to shared storage, e.g., shared access to a set of disk drives and data blocks stored thereon. The nodes in a multi-node database system may be in the form of a group of computers (e.g., workstations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system may be allocated to running a particular database server's software. Each combination of the software and allocation of resources from a node is a server that is referred to herein as a “server instance” or “instance.” A database server may comprise multiple database instances, some or all of which are running on separate computers, including separate server blades.

### Software Overview

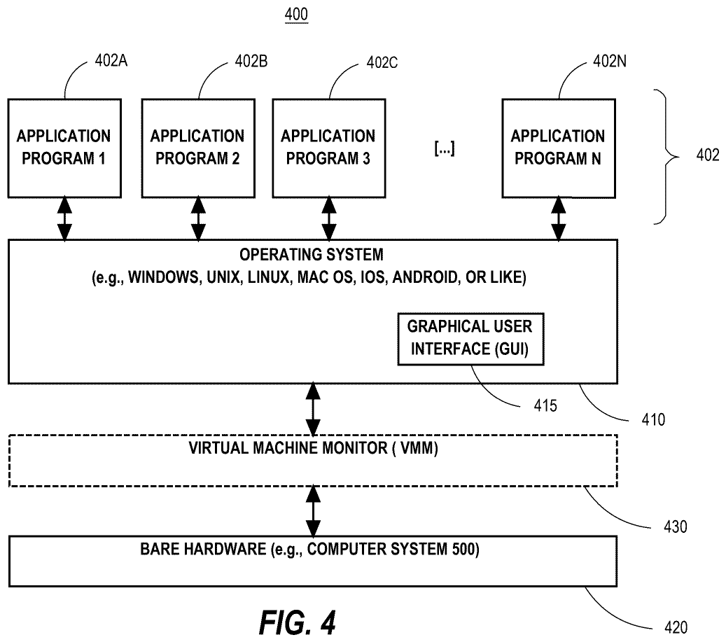

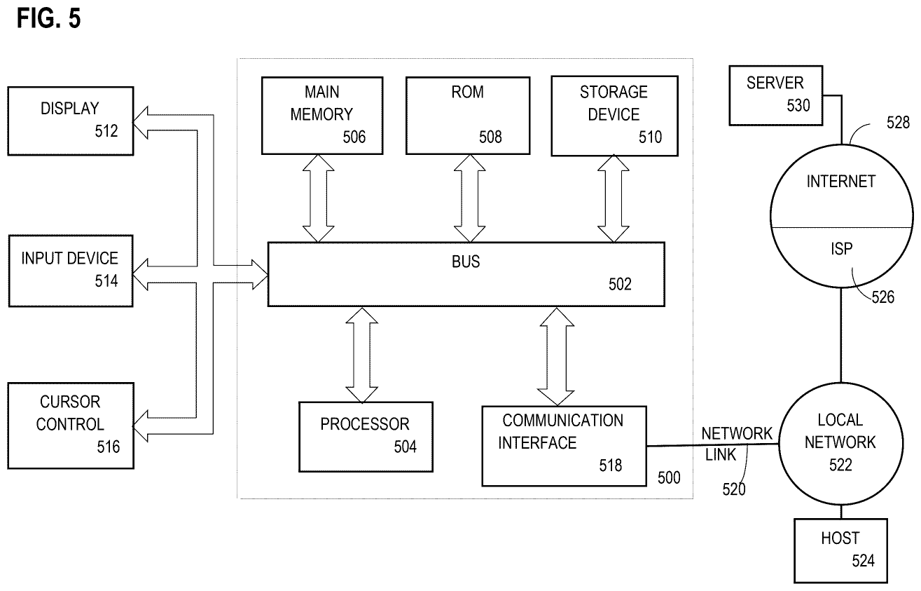

FIG. 4 is a block diagram of a basic software system 400 that may be employed for controlling the operation of computing system 500 of FIG. 5. Software system 400 and its components, including their connections, relationships, and functions, are meant to be exemplary only, and not meant to limit implementations of the example embodiment(s). Other software systems suitable for implementing the example embodiment(s) may have different components, including components with different connections, relationships, and functions.

Software system 400 is provided for directing the operation of computing system 500. Software system 400, which may be stored in system memory (RAM) 506 and on fixed storage (e.g., hard disk or flash memory) 510, includes a kernel or operating system (OS) 410.

The OS 410 manages low-level aspects of computer operation, including managing execution of processes, memory allocation, file input and output (I/O), and device I/O. One or more application programs represented as 402A, 402B, 402C . . . 402N, may be “loaded” (e.g., transferred from fixed storage 510 into memory 506) for execution by the system 400. The applications or other software intended for use on computer system 500 may also be stored as a set of downloadable computer-executable instructions, for example, for downloading and installation from an Internet location (e.g., a Web server, an app store, or another online service).

Software system 400 includes a graphical user interface (GUI) 415, for receiving user commands and data in a graphical (e.g., “point-and-click” or “touch gesture”) fashion. These inputs, in turn, may be acted upon by the system 400 in accordance with instructions from operating system 410 and/or application(s) 402. The GUI 415 also serves to display the results of operation from the OS 410 and application(s) 402, whereupon the user may supply additional inputs or terminate the session (e.g., log off).

OS 410 can execute directly on the bare hardware 420 (e.g., processor(s) 504) of computer system 500. Alternatively, a hypervisor or virtual machine monitor (VMM) 430 may be interposed between the bare hardware 420 and the OS 410. In this configuration, VMM 430 acts as a software “cushion” or virtualization layer between the OS 410 and the bare hardware 420 of the computer system 500.

VMM 430 instantiates and runs one or more virtual machine instances (“guest machines”). Each guest machine comprises a “guest” operating system, such as OS 410, and one or more applications, such as application(s) 402, designed to execute on the guest operating system. The VMM 430 presents the guest operating systems with a virtual operating platform and manages the execution of the guest operating systems.

In some instances, the VMM 430 may allow a guest operating system to run as if it is running on the bare hardware 420 of computer system 500 directly. In these instances, the same version of the guest operating system configured to execute on the bare hardware 420 directly may also execute on VMM 430 without modification or reconfiguration. In other words, VMM 430 may provide full hardware and CPU virtualization to a guest operating system in some instances.

In other instances, a guest operating system may be specially designed or configured to execute on VMM 430 for efficiency. In these instances, the guest operating system is “aware” that it executes on a virtual machine monitor. In other words, VMM 430 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system and may run under the control of other programs being executed on the computer system.

Multiple threads may run within a process. Each thread also comprises an allotment of hardware processing time but share access to the memory allotted to the process. The memory is used to store the content of processors between the allotments when the thread is not running. The term thread may also be used to refer to a computer system process in multiple threads that are not running.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by or within a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers. In a cloud computing environment, there is no insight into the application or the application data. For a disconnection-requiring planned operation, with techniques discussed herein, it is possible to release and then to later rebalance sessions with no disruption to applications.

The above-described basic computer hardware and software and cloud computing environment presented for the purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field-programmable gate arrays (FPGAs) that are persistently programmed to perform the techniques, or may include one or more general-purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general-purpose microprocessor.

Computer system 500 also includes a main memory 506, such as a random access memory (RAM) or another dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read-only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire, and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal, and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic, or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526, in turn, provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510 or other non-volatile storage for later execution.

### Computing Nodes and Clusters

A computing node is a combination of one or more hardware processors that each share access to a byte-addressable memory. Each hardware processor is electronically coupled to registers on the same chip of the hardware processor and is capable of executing an instruction that references a memory address in the addressable memory, and that causes the hardware processor to load data at that memory address into any of the registers. In addition, a hardware processor may have access to its separate exclusive memory that is not accessible to other processors. The one or more hardware processors may be running under the control of the same operating system

A hardware processor may comprise multiple core processors on the same chip, each core processor (“core”) being capable of separately executing a machine code instruction within the same clock cycles as another of the multiple cores. Each core processor may be electronically coupled to connect to a scratchpad memory that cannot be accessed by any other core processor of the multiple core processors.

A cluster comprises computing nodes that each communicate with each other via a network. Each node in a cluster may be coupled to a network card or a network-integrated circuit on the same board of the computing node. Network communication between any two nodes occurs via the network card or network integrated circuit on one of the nodes and a network card or network integrated circuit of another of the nodes. The network may be configured to support remote direct memory access.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method comprising:
receiving a request to store a plurality of documents having a semi-structured data format into a target table of a relational database management system (DBMS);
determining that a particular document in the plurality of documents fails to include an identifier data that uniquely identifies the particular document in the plurality of documents;
generating a particular unique identifier that identifies the particular document in the plurality of documents;
storing each unique identifier of a plurality of identifiers of the plurality of documents into a primary key column of the target table of the relational DBMS, wherein the plurality of identifiers includes the newly generated particular unique identifier;
generating an index of the plurality of documents based on the primary key column of the target table that includes the particular unique identifier for the particular document.

2. The method of claim 1, further comprising:
converting the particular document into a format for storage of semi-structured documents in relational databases, thereby generating a particular encoded document;
wherein converting the particular document into the particular encoded document includes:
traversing the particular document to an identifier field for the particular document, and
determining that the particular document fails to include the identifier data that uniquely identifies the particular document in the plurality of documents based, at least in part, on determining that the identifier field fails to exist in the particular document or contains no valid value.

3. The method of claim 2, wherein converting the particular document into the particular encoded document further includes allocating a particular memory space in the particular encoded document for the identifier data.

4. The method of claim 2, wherein converting the particular document into the format for storage of semi-structured documents in relational databases is performed by a client driver of the relational DBMS.

5. The method of claim 1, further comprising:
converting the plurality of documents into a format for storage of semi-structured documents in relational databases, thereby generating a plurality of encoded documents;
materializing each unique identifier of a plurality of encoded identifiers of the plurality of encoded documents into a corresponding primary key value of a corresponding row of the target table for a respective encoded document of the plurality of encoded documents.

6. The method of claim 5, wherein the format for storage of semi-structured documents in relational databases is a raw-based format.

7. The method of claim 5, wherein the format for storage of semi-structured documents in relational databases is an OSON format.

8. The method of claim 1, wherein the primary key column of the target table is configured to be invisible or immutable.

9. The method of claim 1, further comprising:
converting the plurality of documents into a format for storage of semi-structured documents in relational databases, thereby generating a plurality of encoded documents;
materializing each unique identifier of a plurality of encoded identifiers of the plurality of encoded documents into a corresponding primary key value in a memcomp-compatible format;
storing each encoded document of the plurality of encoded documents into a corresponding row of the target table in association with the corresponding primary key value for the corresponding row of the primary key column of the target table.

10. The method of claim 1, further comprising:
receiving a plurality of encoded documents generated by converting the plurality of documents into a format for storage of semi-structured documents in relational databases;
determining that the particular document in the plurality of documents fails to include the identifier data that uniquely identifies the particular document in the plurality of documents at least by determining that a respective particular encoded document in the plurality of encoded documents contains blank allocated memory space for the identifier data.

11. The method of claim 1, wherein the semi-structured data format is a JSON format or an XML format.

12. One or more non-transitory computer-readable media storing a set of instructions, wherein the set of instructions includes instructions, which, when executed by one or more hardware processors, cause:
receiving a request to store a plurality of documents having a semi-structured data format into a target table of a relational database management system (DBMS);
determining that a particular document in the plurality of documents fails to include an identifier data that uniquely identifies the particular document in the plurality of documents;
generating a particular unique identifier that identifies the particular document in the plurality of documents;
storing each unique identifier of a plurality of identifiers of the plurality of documents into a primary key column of the target table of the relational DBMS, wherein the plurality of identifiers includes the newly generated particular unique identifier;
generating an index of the plurality of documents based on the primary key column of the target table that includes the particular unique identifier for the particular document.

13. The one or more non-transitory computer-readable media of claim 12, wherein the set of instructions further includes instructions, which, when executed by said one or more hardware processors, cause:
converting the particular document into a format for storage of semi-structured documents in relational databases, thereby generating a particular encoded document;
wherein converting the particular document into the particular encoded document includes:
traversing the particular document to an identifier field for the particular document, and
determining that the particular document fails to include the identifier data that uniquely identifies the particular document in the plurality of documents based, at least in part, on determining that the identifier field fails to exist in the particular document or contains no valid value.

14. The one or more non-transitory computer-readable media of claim 13, wherein converting the particular document into the particular encoded document further includes allocating a particular memory space in the particular encoded document for the identifier data.

15. The one or more non-transitory computer-readable media of claim 12, wherein the set of instructions further includes instructions, which, when executed by said one or more hardware processors, cause:
converting the plurality of documents into a format for storage of semi-structured documents in relational databases, thereby generating a plurality of encoded documents;
materializing each unique identifier of a plurality of encoded identifiers of the plurality of encoded documents into a corresponding primary key value of a corresponding row of the target table for a respective encoded document of the plurality of encoded documents.

16. The one or more non-transitory computer-readable media of claim 15, wherein the format for storage of semi-structured documents in relational databases is a raw-based format.

17. The one or more non-transitory computer-readable media of claim 15, wherein the format for storage of semi-structured documents in relational databases is an OSON format.

18. The one or more non-transitory computer-readable media of claim 12, wherein the set of instructions further includes instructions, which, when executed by said one or more hardware processors, cause:
converting the plurality of documents into a format for storage of semi-structured documents in relational databases, thereby generating a plurality of encoded documents;
materializing each unique identifier of a plurality of encoded identifiers of the plurality of encoded documents into a corresponding primary key value in a memcomp-compatible format;
storing each encoded document of the plurality of encoded documents into a corresponding row of the target table in association with the corresponding primary key value for the corresponding row of the primary key column of the target table.

19. The one or more non-transitory computer-readable media of claim 12, wherein the set of instructions further includes instructions, which, when executed by said one or more hardware processors, cause:
receiving a plurality of encoded documents generated by converting the plurality of documents into a format for storage of semi-structured documents in relational databases;
determining that the particular document in the plurality of documents fails to include the identifier data that uniquely identifies the particular document in the plurality of documents at least by determining that a respective particular encoded document in the plurality of encoded documents contains blank allocated memory space for the identifier data.

20. The one or more non-transitory computer-readable media of claim 12, wherein the semi-structured data format is a JSON format or an XML format.
